(19) United States
(12) Patent Application Publication
(10) Pub. No.: US 2015/0363650 A1
(43) Pub. Date: Dec. 17, 2015

(54) Distracted Driving Violation Detection and Reporting Technology

(71) Applicant: Mauricio Braun, Agoura, CA (US)

(72) Inventor: Mauricio Braun, Agoura, CA (US)

(21) Appl. No.: 14/737,850

(22) Filed: Jun. 12, 2015

Related U.S. Application Data
(60) Provisional application No. 62/012,154, filed on Jun. 13, 2014.

(51) Int. Cl. G06K 9/00; G06K 9/62; G06Q 50/26; G06K 9/32

(52) U.S. Cl. CPC G06K 9/00771; G06K 9/3258; G06K 9/6267; G06Q 50/265

(57) ABSTRACT

A method and system for detecting and reporting distracted driving violations and sending a citation to the registered owner of the vehicle being driven by the distracted driver. The system involves a processing station receiving photographic images of the distracted driver, his or her license plate number, and optionally his or her vehicle by a patroller, processing the photographic images to identify the owner of the vehicle, generating a citation, and sending the citation to the registered owner. The registered owner can either pay the fine or dispute the allegation. If the allegation is disputed, the matter can be turned over the legal system for proper adjudication.

### CROSS-REFERENCE TO RELATED APPLICATION

This patent application claims the benefit of U.S. Provisional Patent Application Ser. No. 62/012,154, entitled “Distracted Driving Violation Detection and Reporting Technology,” filed Jun. 13, 2014, which application is incorporated herein in its entirety by this reference.

### TECHNICAL FIELD

This invention relates to a system and method for detecting and reporting distracted driving violations.

### BACKGROUND

Distracted driving is defined as driving a motorized vehicle while performing any activity which could potentially distract the driver from the primary task of operating the motorized vehicle. In theory, it can be anything that could take a driver's eyes off the road, or distract the mental concentration of the driver away from driving. While distracted driving is an umbrella term covering many behaviors, many states have enacted laws against it. States take a variety of approaches to punishing distracted driving, ranging from general to specific bans on the particular types of distractions.

Most recently, the prevailing distraction tends to involve use of an electronic device carried or viewed by the driver. More specifically, the distraction is the smartphone, but the present invention applies to distractions caused by any electronic devices, including but not limited to, regular cellular phones (i.e., “flip” phones), tablets (e.g., iPads), “phablets,” navigation devices, and the like. Smartphones have come to the point where they are basically miniature computers with the capabilities of making calls, sending and receiving emails, sending and receiving text messages, playing videos, surfing the Internet, and providing navigation assistance, among other things. In particular, use of smartphones, including texting, has become so rampant and dangerous for drivers that some states have banned such activities from being undertaken while one is driving a motorized vehicle. Furthermore, other distracting activities, such as making a phone call without a hands-free device, browsing the internet, checking e-mails, programming a navigation device, and the like make driving equally dangerous and needs to be stopped.

Some reports indicate that texting while driving results in more than 3,000 deaths and 300,000 injuries of teenagers annually. With teenagers, texting while driving now causes more deaths and injuries than drinking while driving. A report from http://www.distraction.gov/content/get-the-facts/facts-and-statistics.html indicates that the number killed in distraction-affected crashes appeared to be decreasing from 3,360 in 2011 to 3,328 in 2012. This website reported an estimated 421,000 injuries due to distracted driving in 2012, which was up from 387,000 injuries due to distracted driving in 2011.

Even though most states have enacted laws to prevent texting while driving, among other distracting activities, these laws have been largely ineffective in deterring these dangerous activities. Although distracted driving may be reduced immediately after a law has been enacted, drivers tend to go back to their old habits and ignore the law, most likely because most are able to “get away with it.” If distracted drivers are not cited for violating the law, they will continue to drive in a distracted manner and endanger others.

Enforcement has been particularly difficult because it is hard to prove that a driver was texting, e-mailing, browsing the Internet, etc., while driving. Thus, the laws do not deter texting, or other distracting activities, while driving because the laws are not adequately enforced.

Not every jurisdiction has enacted laws against all types of distracted driving. For example, states like California have determined that utilizing a navigation feature on a GPS or similar device while driving is acceptable. Laws may vary from state to state, and current laws have not adequately deterred distracted driving. Eventually, as accidents continue to increase, every jurisdiction will likely have their regulations and traffic laws modified as technology evolves to address this increasing problem.

For the foregoing reasons, there is a need for a system and method for deterring distracted driving. Only when drivers know there is a high probability that they will be caught in the act of violating a distracted driving law, and punished, will drivers begin to obey distracted driving laws.

### SUMMARY

The present invention is directed to a method and system for easily detecting and reporting distracted driving violators and sending a citation to the registered owner of the vehicle being driven by the distracted driver. The system involves: a processing station receiving photographic images of the distracted driver, his or her license plate number, and optionally his or her vehicle by a patroller; processing the photographic images to identify the owner of the vehicle; generating a citation; and, sending the citation to the registered owner. The registered owner can either pay the fine or dispute the citation. If the citation is disputed, the matter can be turned over to the legal system for proper adjudication.

### BRIEF DESCRIPTION OF DRAWINGS

FIG. 1 shows a flow diagram of an embodiment of the present invention.

FIG. 2A shows a photographic equipment taking a photograph of a distracted driving violation incident;

FIG. 2B shows an embodiment of a citation; and

FIG. 3 shows a high level block diagram of an embodiment of the present invention.

### DETAILED DESCRIPTION OF THE INVENTION

The detailed description set forth below in connection with the appended figures is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

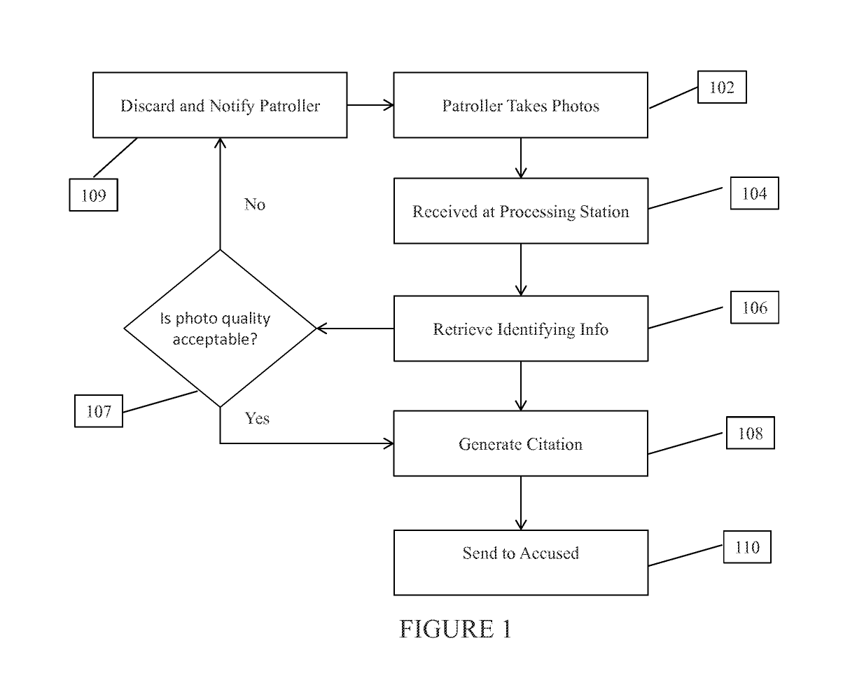

As shown in FIG. 1, the system and method for penalizing a distracted driver engaged in a distracted driving violation comprises: a processing station for receiving photographs 104 from a patrol operator or patroller who has witnessed the distracted driving violation and taken one or more photographs 102 (e.g., photographs of the distracted driver engaged in the distracted driving violation, the vehicle being driven by the distracted driver, the license plate of the vehicle being driven by the distracted driver, and the like); processing the license plate information of the vehicle involved in the distracted driving 106; generating a distracted driving citation 108; and, sending the distracted driving citation to the registered owner of the vehicle 110 involved in the distracted driving violation. For the purposes of this application, the terms “photograph,” “photographic images,” and variations thereof include not only still images (digital or similar format), but also videos, which are essentially a series of still images. For purposes of this invention, a “patrol operator” or “patroller” (or similar references), may include, but is not limited to, police or other law enforcement personnel.

The speed with which the photographed violation is transmitted to the processing station minimizes and possibly eliminates any opportunity for doctoring a photographic image by those who may try to abuse the system for purposes of harassment, annoyance, or financial benefit, rather than the legitimate reason of trying to reduce distracted driving. In some embodiments, a citation may be generated in five minutes or less. For example, the citation may be generated immediately after receiving the photographed violation, meaning as soon as the processing station receives the photographic images, it begins generating the citation.

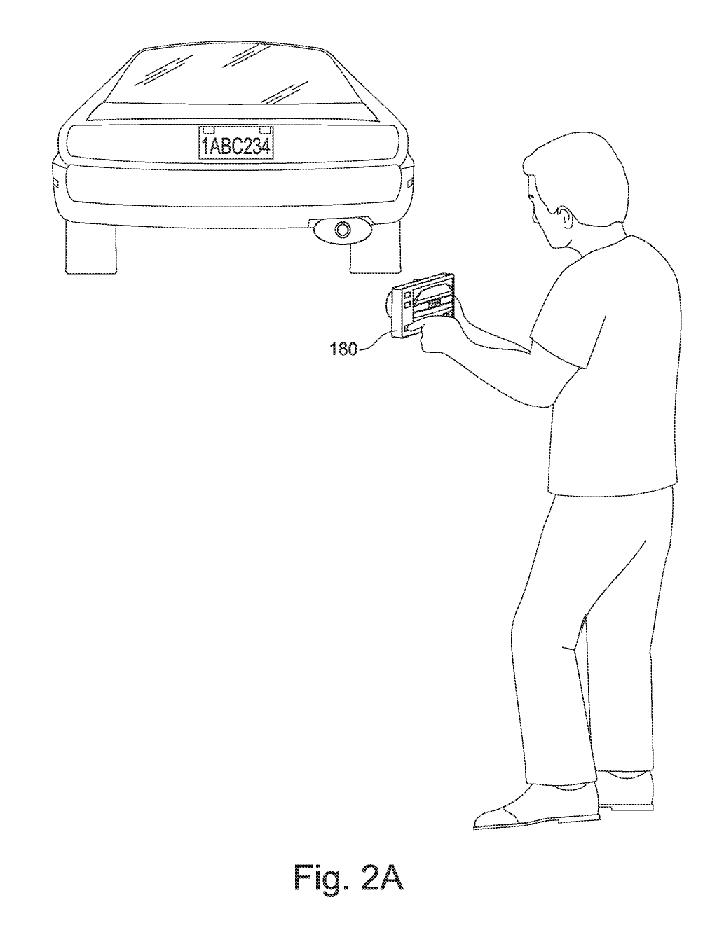

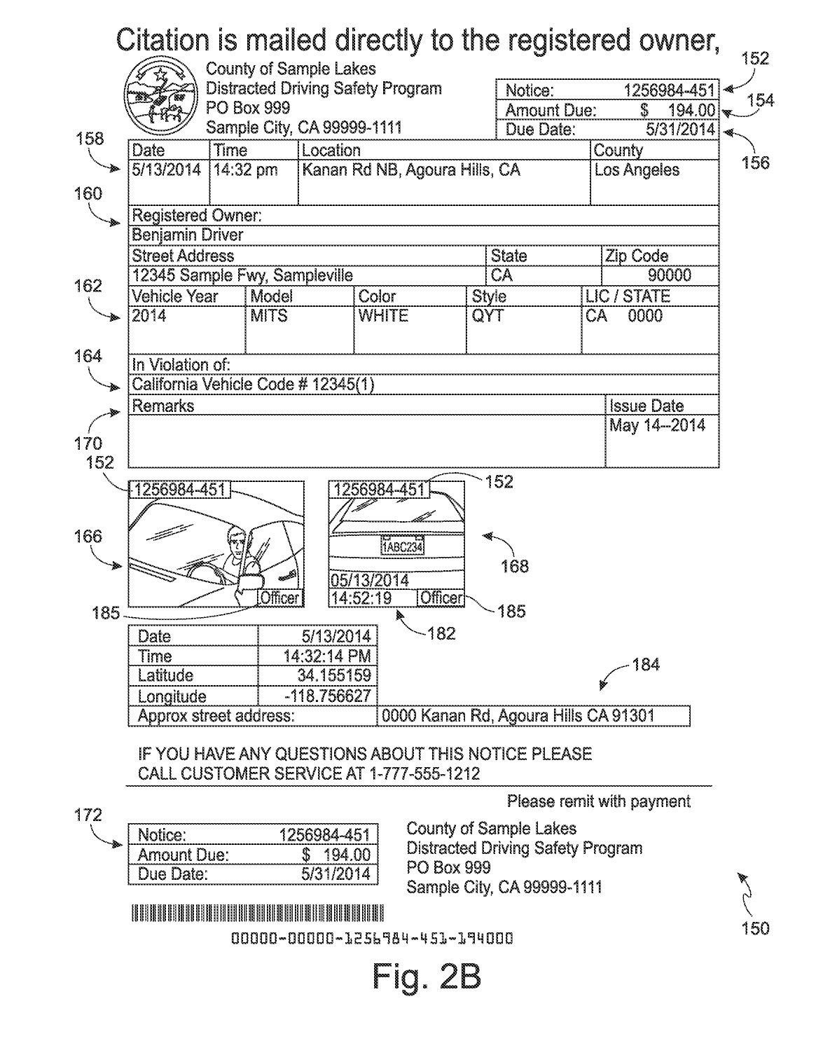

As shown in FIGS. 2A and 2B, the photographic equipment 180 may be capable of providing a time stamp 182 to record the date and time when the photographs are taken. In addition, the photographic equipment 180 may be equipped with location tracking technology, such as a receiver or antenna that can be used with satellite navigation systems, local area networks (LAN and wireless LAN), multilateration of radio signals, Wi-Fi-based positioning systems, and any other technology that can identify the location of the photographic equipment 180, so as to identify the location 184 (e.g. latitude and longitude, address, etc.) where the photographs are being taken. Therefore, when the photographic images 166, 168 are sent to the processing station, time, date, and location information may be simultaneously sent. These and other pieces of information related to the distracted driving violation event may be sent embedded on the photographic images that is visible, or as metadata that may not be seen by a viewer, but can be read and recorded by a computer.

In some embodiments, the photographic equipment 180 is configured to group photographic images 166, 168 together as evidence of a single violation. This can be done manually by the patroller or it can be done automatically. Automatically means that the photographic equipment 180 is programmed to perform the desired function at the desired time or upon a predetermined event, i.e. clicking a button. For example, the grouping and transmission of photographic images 166, 168 of a single violation can be achieved by a timing mechanism. It may be presumed by mechanisms in the photographic equipment 180 and related transmission apparatuses that all photographic images 166, 168 captured within a specified time frame are related to the same violation. The specified time frame should be long enough to allow the patroller to capture images of the violation, the vehicle, and the license plate. For example, the specified period may be within 1 minute, 2 minutes, 3 minutes, 4 minutes, or 5 minutes, and sometimes longer depending on the circumstances. The group of photographic images 166, 168 can be automatically tagged with the same case number 152. Therefore, if the photographic equipment 180 detects a series of photographic images 166, 168 captured within a designated time period it will group them as a single case and transmit the grouped photographs 166, 168 to the processing station as a single case.

By automatically capturing and transmitting these photographic images 166, 168, the patroller saves a tremendous amount of time and improves the safety of all involved since there is no need to pull anybody over. There is no need for the patroller to process any information or even request that the information be sent. All the patroller has to do is capture images of the alleged violation, preferably within a designated time frame. The patroller does not have to prepare any paperwork or make any calls to dispatch.

The patroller may be an authorized government agent, such as a police officer, traffic officer, parking enforcer, or even a newly established agency. In some embodiments, an average citizen may be a patroller. Or, companies may be established that provide patrolling services. Patrollers can be moving about via the typical modes of transportation, such as automobiles, motorcycles, ATV's, bicycles, horses, by foot, and the like. In some embodiments, the patrollers may be stationary at a designated post. In some embodiments, the photographic equipment 180 may also contain the identifying information of the patroller 185. The patroller's identification 185 can then be transmitted with any photographic images 166, 168 embedded in the photographic image or as metadata that can be read and recorded by a computer. Therefore, in the event of a dispute, the patroller can be notified to testify. For government agencies, the identifying information can be registered with the photographic equipment 180 assigned to the government official.

In the embodiment where an average citizen is the patroller, the average citizen may have to download an application (“app”) for a smartphone. Therefore, the photographic equipment 180 may be the smartphone. In agreeing to the terms and conditions, for example, the citizen's information may be extracted. Thus, in order to report a distracted driver through this system, the citizen would have to open the app, which automatically launches the camera. Then any photographs taken through the app would automatically submit the photos and the citizen's identifying information so that a citation can be processed in the manner as generally described herein.

Once the photographic images 166, 168 are taken, the images are transmitted, preferably automatically, to the processing station. The images can be transmitted via radio waves, LAN, wireless LAN, and the like. Once the processing station receives the photographic images, each image is reviewed either manually or through automated means to determine the quality 107 of the images, particularly the image containing the license plate. The license plate is read and the state that issued the license plate is identified. Based on the license plate information, the registered owner of the vehicle can be identified and his or her residence ascertained. This can be accomplished by searching the Department of Motor Vehicles (or similar entity) database of the state that issued the license plate. In some embodiments, reading the license plate can be done automatically using optical character recognition (OCR) or similar processes. Therefore, quality control checks 107 can be established to assure OCR is accurate. For example, algorithms may be established for determining whether a license plate number could be read clearly (i.e. license plate is legible) or for determining the confidence level of the read. Readings below a threshold level can be flagged for a secondary review, for example, by a person.

Images that fall below a predetermined confidence level, for example, images that are incomplete (i.e. does not show the driver violating a distracted driving law or does not show the complete license plate number) or illegible, may be discarded so as not to waste resources. In some embodiments, a message may be sent 109 to the patroller from the processing station indicating that the images are inadequate, e.g., incomplete or illegible. This will alert the patroller to capture another set of images, if possible.

The processing station can generate a distracted driving citation form 150 indicating the nature of the violation and the fine for the violation with instructions on how to respond to the citation. FIG. 2B shows a sample of a citation form 150. The format and data contained on the citation form 150 can be customized according to the requests and approvals granted by the specific jurisdiction, and may vary accordingly. In general, as shown in FIG. 2B, the citation form may show the case number 152, the amount of the fine 154, the date the fine is due 156, the date, time and location of the violation 158, the registered owner's identifying information 160, the vehicle information 162, the nature of the violation 164, photographs of the driver engaged in the violation 166, photographs of the license plate number and vehicle 168, additional remarks 170, and the like. In some embodiments, a payment stub 172 may be provided to facilitate payment.

The accused violator can pay the fine, in which case the matter would be disposed. If the processing station, or other entity, receives the appropriate amount of the fine, the case is resolved. If not, follow up communications may be sent as a reminder to pay the fine in full. In some embodiments, a record is kept of the violation so that the fine or punishment can be increased commensurately with the frequency or severity of the violation.

Alternatively, the accused violator can dispute the violation. If the processing system receives an indication that the accused violator will dispute the alleged violation, then the processing station reports and turns the matter over to the judicial system for further processing. Once the matter is resolved by the judicial system, the disposition of the case may be reported to the processing station or other entity and recorded.

In some embodiments, to keep traffic violations within the jurisdiction of law enforcement, the processing station may be a part of the police station or some other law enforcement agency, traffic enforcement agency, or government agency.

The photographic equipment 180 may be any type of digital camera or electronic device having a digital camera. For example, the photographic equipment may be a stand-alone digital camera, a smartphone, a tablet, or the like. In any case, apps may be created for download to use with the photographic equipment to carry out the processes described herein.

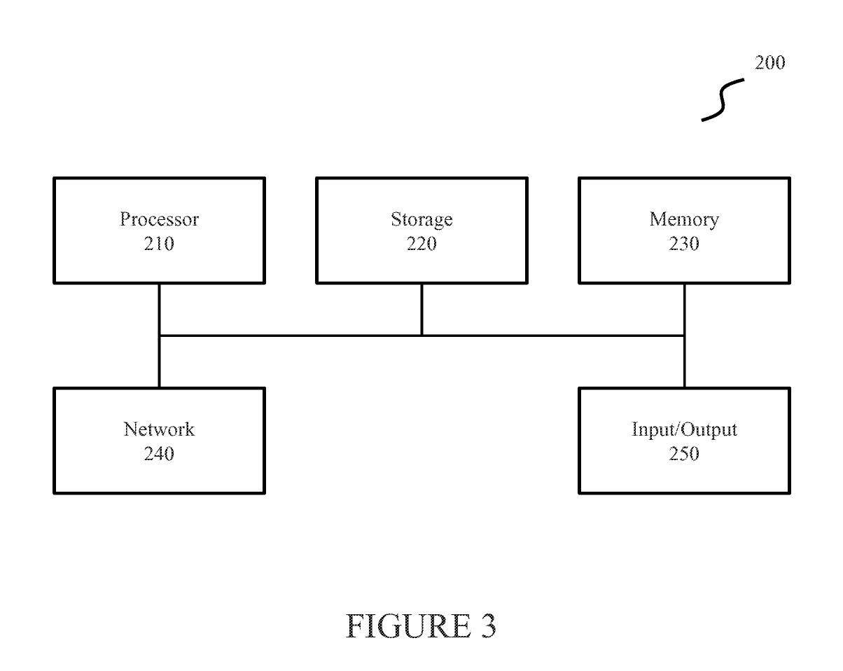

As such, the photographic equipment may be configured as shown in FIG. 3, with a computing device 200 comprising a processor 210 operatively coupled to a data storage device 220 and memory 280. A high-level block diagram of an exemplary computing device 200 that may be used to implement systems, apparatus, and methods described herein is illustrated in FIG. 3. Processor 210 controls the overall operation of computer 200 by executing computer program instructions that define such operations. The computer program instructions may be stored in data storage device 220, or other non-transitory computer readable medium, and loaded into memory 230 when execution of the computer program instructions is desired. Thus, the method steps of FIG. 1 can be defined by the computer program instructions stored in memory 230 and/or data storage device 220 and controlled by processor 210 executing the computer program instructions.

Computer 200 also includes one or more network interfaces 240 for communicating with other devices via a network. Computer 200 also includes one or more input/output devices 250 that enable user interaction with computer 200 (e.g., display, touchscreen, keyboard, touchpad, mouse, speakers, buttons, dials, etc.).

Processor 210 can include, among others, special purpose processors with software instructions incorporated in the processor design and general purpose processors with instructions in storage device 220 or memory 230, to control the processor 210, and may be the sole processor or one of multiple processors of computer 200. Processor 210 may be a self-contained computing system, containing multiple cores or processors, a bus, memory controller, cache, etc. A multi-core processor may be symmetric or asymmetric. Processor 210, data storage device 220, and/or memory 230 may include, be supplemented by, or incorporated in, one or more application-specific integrated circuits (ASICs) and/or one or more field programmable gate arrays (FPGAs).

Data storage device 220 and memory 230 each comprise a tangible non-transitory computer readable storage mediums. By way of example, and not limitation, such non-transitory computer-readable storage medium can include random access memory (RAM), high-speed random access memory (DRAM), static random access memory (SRAM), double data rate synchronous dynamic random access memory (DDRRAM), read-only memory (ROM), erasable programmable read-only memory (EPROM), electrically erasable programmable read-only memory (EEPROM), flash memory, compact disc read-only memory (CD-ROM), digital versatile disc read-only memory (DVD-ROM) disks, or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Network/communication interface 240 enables the computer 200 to communicate with networks, such as the Internet, also referred to as the World Wide Web (WWW), an intranet and/or a wireless network, such as a cellular telephone network, a wireless local area network (LAN) and/or a metropolitan area network (MAN), and other devices using any suitable communications standards, protocols, and technologies. By way of example, and not limitation, such suitable communications standards, protocols, and technologies can include Ethernet, Token Ring, Wi-Fi (e.g., IEEE 802.11), Wi-MAX (e.g., 802.16), Bluetooth, near field communications (“NFC”), radio frequency systems, infrared, GSM, EDGE, HS-DPA, CDMA, TDMA, quad band, VoIP, IMAP, POP, XMPP, SIMPLE, IMPS, SMS, or any other suitable communications protocols. By way of example, and not limitation, the network interface 240 enables the computer 200 to transfer data, synchronize information, update software, or any other suitable operation.

Input/output devices 250 may include peripherals, such as a printer, monitor, external drive, etc. Input/output devices 250 may also include parts of a computing device, such as a smartphone having a touchscreen, speakers, and buttons. For example, input/output devices 250 may include a display device such as a liquid crystal display (LCD) monitor for displaying information to the user, a keyboard and mouse by which the user can provide input to the computer 200, or a touchscreen for both input and output.

Any or all of the systems and apparatus discussed herein, including personal computers, tablet computers, hand-held devices, cellular telephones, servers, database, cloud computing environments, and components thereof, may be implemented using a computer such as computer 200.

One skilled in the art will recognize that an implementation of an actual computer or computer system may have other structures and may contain other components as well, and that FIG. 3 is a high level representation of some of the components of such a computer for illustrative purposes.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method for reporting distracted driving violations, comprising:
a. receiving photographic images at a processing station, the photographic images captured on a photographic equipment by a patroller who witnessed the distracted driving violation and captured the photographic images of the distracted driving violation, wherein the photographic images comprise an image of the vehicle, an image of a driver of the vehicle, and an image of a license plate of the vehicle;
b. automatically receiving at the processing station the photographic images and identification information of the patroller, a time stamp of the date and time when the photographic images were taken, and location information of where the photographic images were taken;
c. automatically tagging the photographic images with a case number when the photographic images are received at the processing center within a predetermined time frame;
d. processing the image of the license plate of the vehicle involved in the distracted driving violation;
e. reviewing the photographic images to determine whether the photographic images contain the license plate;
f. establishing a confidence level for determining whether the license plate is legible, wherein when the confidence level is below a predetermined threshold, the photographic images are discarded and a message is sent to the patroller from the processing station indicating that the photographic images are inadequate;
g. generating a distracted driving citation in five minutes or less of receiving the photographic images;
h. sending the distracted driving citation to a registered owner of the vehicle involved in the distracted driving violation, wherein the distracted driving citation documents a nature of the violation, a fine for the violation, and instructions on how to respond to the distracted driving citation; and
i. if the processing station receives an appropriate amount for the fine, resolving the case, and if the processing station does not receive the appropriate amount for the fine by a designated deadline, sending a follow up communication.

2. A method for reporting distracted driving violations, comprising:
a. receiving photographic images at a processing station, the photographic images captured on a photographic equipment by a patroller who witnessed the distracted driving violation and took the photographic images of the distracted driving violation, wherein the photographic images comprise images of a vehicle involved in the distracted driving violation, a driver of the vehicle, and a license plate of the vehicle;
b. processing the license plate of the vehicle involved in the distracted driving violation;
c. generating a distracted driving citation; and
d. sending the distracted driving citation to a registered owner of the vehicle involved in the distracted driving violation.

3. The method of claim 2, further comprising reviewing the photographic images to determine whether the photographic images contain the license plate.

4. The method of claim 3, further comprising establishing a confidence level for determining whether the license plate is legible, wherein when the confidence level is below a predetermined threshold, the photographic images are discarded.

5. The method of claim 4, further comprising sending a message to the patroller from the processing station indicating that the images are inadequate.

6. The method of claim 2, wherein the photographic images are grouped together as evidence of a single violation when received from the same photographic equipment within a predetermined time frame.

7. The method of claim 2, wherein the distracted driving citation is generated immediately after receiving the photographic images.

8. The method of claim 2, further comprising automatically tagging the photographic images with a case number.

9. The method of claim 2, wherein the photographic images are sent with an identification of the patroller.

10. The method of claim 2, wherein the distracted driving citation states a nature of the violation, a fine for the violation, and instructions on how to respond to the distracted driving citation.

11. The method of claim 10, wherein if the processing station receives an appropriate amount for the fine, the case is resolved, and if the processing station does not receive the appropriate amount for the fine by a designated deadline, a follow up communication is sent to the registered owner.

12. The method of claim 2, further comprising sending a time stamp to record a date and time when the photographic images were taken.

13. The method of claim 2, further comprising sending a location information to identify a location where the photographic images were taken.

14. The method of claim 2, further comprising automatically receiving the photographic images at the processing station.

15. A photographic equipment for reporting distracted driving violations, the photographic equipment comprising at least one processor; a database for storing photographic images; and a memory operatively coupled to the processor, the memory storing program instructions that when executed by the processor, causes the processor to:
a. capture photographic images, wherein the photographic images comprise images of a vehicle involved in the distracted driving violation, a driver of the vehicle, and a license plate of the vehicle; and
b. send the photographic images to a processing station.

16. The photographic equipment of claim 15, wherein the photographic equipment is configured to group the photographic images together as evidence of a single violation by grouping and transmitting photographic images taken within a predetermined time frame.

17. The photographic equipment of claim 16, wherein the photographic equipment comprises an identification of the patroller, and the identification of the patroller is transmitted with the photographic images.

18. The photographic equipment of claim 17, wherein the photographic equipment provides a time stamp to record a date and time when the photographic images were taken.

19. The photographic equipment of claim 17, wherein the photographic equipment is equipped with a location tracking technology to identify a location where the photographic images were taken.

20. The photographic equipment of claim 17, comprising automatically sending the photographic images to the processing station.
